(19) United States
(12) Patent Application Publication
(10) Pub. No.: US 2006/0255231 A1
(43) Pub. Date: Nov. 16, 2006

(54) Christmas tree stand

(75) Inventors: Dianne Rainford, St. Helens (GB); Richard Rainford, St. Helens (GB); John Cook, Wirral (GB)

Correspondence Address: GREENSFELDER HEMKER & GALE PC, SUITE 2000, 10 SOUTH BROADWAY, ST LOUIS, MO, 63102, US

(73) Assignee: Christmas Innovations Ltd of New Farm Rural Industries

(21) Appl. No.: 11/128,945

(22) Filed: May 13, 2005

(51) Int. Cl. F16M 13/00

(52) U.S. Cl. 248/523

(57) ABSTRACT

A tree stand substantially comprising at least three generally vertical upright members, at least as many supporting members as upright members and a continuous connecting member. Wherein said upright members are positioned such that the trunk of a tree may be slotted between and be supported by said upright members in a substantially upright position, each supporting member is rigid, is fixed at one end to one of the upright members such that there is at least one supporting member attached to each upright member, and extends generally radially outwards from its associated upright member in such a manner that its other end is level with or lower than the base of the upright member to which it is attached and when the stand is in use the stand rests on and is supported by the connecting member or radially outmost end portions of all the supporting members and said continuous connecting member joins all of said upright members and all of said supporting members in a reinforcing manner such that the stand is a single rigid object.

The invention provides a simple non-mechanical stand in which natural Christmas trees and other ornamental rootless trees may be supported.

### BACKGROUND

The display of decorated fir and spruce trees over the Christmas period is common place in many countries. However the support of these trees is not straightforward as they usually have no root structure and so must be supported by their lower trunk alone. Additionally the trees are not permanent fixtures and are on display for a maximum of six weeks only. In fact, in many cases the tree is on display for such a short length of time there is not a need to supply the tree with water or nutrients thus making the display of the tree some what easier, although needle loss is reduced if the tree is able to stand in water.

It is possible for an individual to construct a stand for a Christmas tree. For example the lower branches may be stripped from the trunk and the tree could be potted in sand or soil in a bucket in a similar way to a conventional rooted ornamental tree. Despite this there is still a great desire for commercially produced, convenient and reusable stands. In order to meet this demand there are currently a plethora of commercially available stands which have been specifically designed for Christmas trees. For the sake of discussion these stands may be split into two categories.

The first category consists of ready constructed stands that have a hole in their centre through which the trunk of the Christmas tree is placed, the tree then being held in place by some sort of mechanical clamping mechanism. The most common examples of the clamping mechanism are inwardly facing radial screws that pass through hole in the centre of the stand and may be tightened into the tree, thereby clamping it in the upright position. Alternatively there are also more complex mechanisms, such as spring loaded clamping members which are arranged around the hole so as to clamp the tree in position. These stands have a number of drawbacks. Firstly, they tend to be bulky and so take up a lot of storage space, in retail outlets and in the home. This is a particular problem for retailers as the stands' relative bulk drives up the cost of transporting, packaging and storing the stands, thereby making them more expensive than they might otherwise be. Their second problem is the inclusion of a mechanical clamping means. Inevitably a large amount of stress will be placed on these clamping means. This stress coupled with the possibility of maladjustment by the end user means the clamping means are often damaged through use and the stand may either break entirely or be much more difficult to set up in subsequent Christmases. Finally, in general these stands are fairly complex to manufacture as they necessarily have several parts and need to be fully constructed before sale. This means these stands tend to be relatively expensive compared to the second category of stands

The second nominal category of Christmas tree stands is composed of those stands that are self-assembly and need to be constructed around the tree each time it is erected. These stands are either constructed around the trunk of the tree such that the tree is firmly clamped in the upright position during the construction, or they may be constructed around the tree and then have some sort of clamping mechanism which is engaged to hold the tree in the upright position. These stands also have their drawbacks. Self-construction, despite how apparently simple it may often seem, is very often deceptively difficult especially for the infirm. Construction of these stands can cause hours of frustration and the constructor often gives up before the stand is entirely correctly constructed and adjusted. This can lead to the erected tree being unsafe, in danger of toppling and may even cause damage to the stand. Additionally these stands may even be damaged by repeated construction and deconstruction at the beginning and end respectively of each tree's tenure. There is also the simple fact that many people are just too lazy to consider purchasing a tree stand that they will have to construct themselves. Thus there is a need for a simple non-mechanical Christmas tree stand that may be reused, that is cheap and that is simple to set-up.

### SUMMARY OF THE INVENTION

The invention provides a tree stand substantially comprising at least three generally vertical upright members, at least as many supporting members as upright members and a continuous connecting member. Wherein said upright members are positioned such that the trunk of a tree may be slotted between and be supported by said upright members in a substantially upright position, each supporting member is rigid, is fixed at one end to one of the upright members such that there is at least one supporting member attached to each upright member, and extends generally radially outwards from its associated upright member in such a manner that its other end is level with or lower than the base of the upright member to which it is attached and when the stand is in use the stand rests on and is supported by the connecting member or radially outmost end portions of all the supporting members and said continuous connecting member joins all of said upright members and all of said supporting members in a reinforcing manner such that the stand is a single rigid object.

The invention provides a simple non-mechanical tree stand that will support a correctly sized Christmas tree indefinitely. It requires little effort and no technical expertise to display a tree in the stand. The user merely slots the trunk of the tree between the upright members by lowering the tree in from above. As the tree may also be easily removed by the reverse of this process the stand is entirely reusable may be used year after year. As the stand has no mechanical parts it is highly unlikely that it will be damaged by such repeated use. Additionally the stand may provide support over a long length of the trunk of a supported tree as the upright members extend upwardly between the tree's lower branches. This means that the trunk of the tree may be supported by the upright members over a height that extends well above these branches. As well as adding a greater stability to the tree than would otherwise be possible this also enables a tree with branches very near its base to be displayed. In many conventional stands these branches would have to be pruned away before the tree could be displayed so that a significant length of bare trunk could be supported. In contrast the stand of this invention may display a tree with branches only just above the base of its trunk.

### BRIEF DESCRIPTION OF THE DRAWINGS

FIG. 1 shows a first embodiment of the invention,

FIG. 2 shows a second embodiment of the invention,

FIG. 3 shows the first embodiment of the invention placed over a water container,

FIG. 4 shows the first embodiment of the invention in use,

FIG. 5 shows a third embodiment of the invention,

FIG. 6 shows a fourth embodiment of the invention,

FIG. 7 shows a fifth embodiment of the invention,

FIG. 8 shows a sixth embodiment of the invention,

FIG. 9 shows a seventh embodiment of the invention,

FIG. 10 shows an eighth embodiment of the invention,

FIG. 11 shows a ninth embodiment of the invention,

FIG. 12 shows a tenth embodiment of the invention,

FIG. 13 shows an eleventh embodiment of the invention,

FIG. 14 shows a twelfth embodiment of the invention,

FIG. 15 shows a thirteenth embodiment of the invention,

FIG. 16 shows a fourteenth embodiment of the invention,

FIG. 17 shows a fifteenth embodiment of the invention,

FIG. 18 shows a sixteenth embodiment of the invention,

FIG. 19 shows a seventeenth embodiment of the invention,

FIG. 20 shows a nineteenth embodiment of the invention,

FIG. 21 shows a twentieth embodiment of the invention,

FIG. 22 shows a twenty-first embodiment of the invention.

### DETAILED DESCRIPTION

As an illustration several preferred embodiments of the invention and their respective advantages will now be described with reference to the figures.

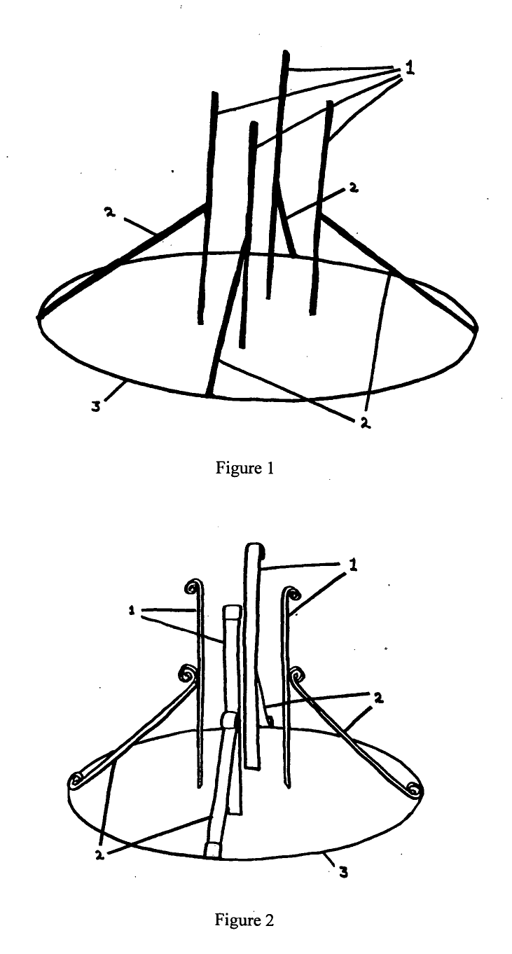

FIG. 1 shows a first embodiment of the invention. This stand has four upright members 1 which are equally spaced around a central cylindrical space into which the trunk of a Christmas tree may be slotted. The upright members 1 are attached by supporting members 2 to a circular connecting member 3. The connecting member 3 is flat and positioned such that the base of the tree supported in the stand will be situated in its centre therefore making the connecting member 3 a stable base upon which the stand may rest. The supporting members 2 are each attached at one end to the approximate vertical midpoint of an associated upright member 1 and extend downwards and radially outwards from this point such that they are attached to the connecting member 3 at their other end. The stand will support trees which have a trunk that has the same or slightly smaller diameter than the central cylindrical space. It is anticipated that in order that most Christmas trees will be able to be supported stands of many different sizes will be produced. The consumer would then purchase the stand which corresponds to the size of tree he wishes to display.

The construction of the stand is such that the constituent parts of the stand comprise simple steel rods that have been cut to length and in the case of the connecting member 3 formed to the correct shape. These parts have then been welded together at their junctions to form a rigid stand. Additionally, the steel may be protected against corrosion by a coating. For example the rods may be plastic coated, painted or galvanized.

Alternatively the separate parts of the stand may be made out of any other rigid and resilient material. FIG. 2 shows a stand in which the upright members 1 and supporting members 2 have been made from wrought iron bars whilst the connecting member remains a simple hoop. Other possible materials include rigid plastics, aluminium and wood.

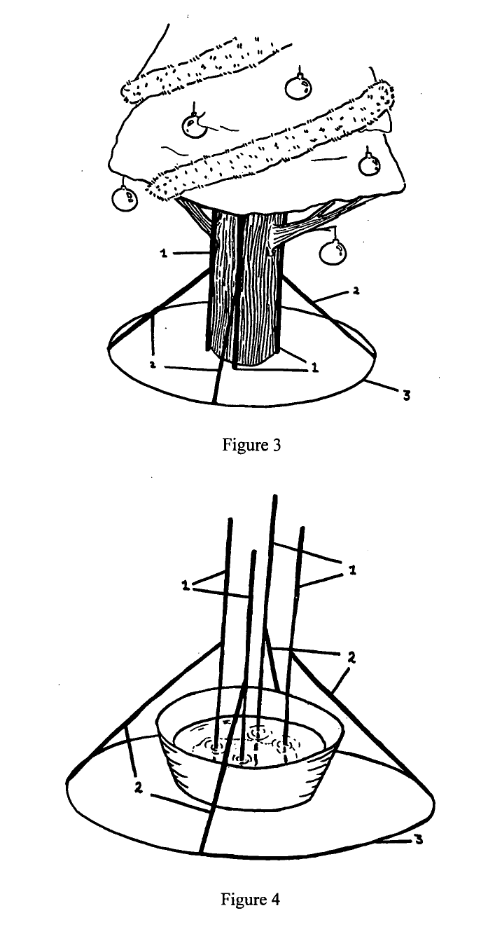

FIG. 3 shows the stand of FIG. 1 in use. In order to situate the tree in the stand the trunk of the tree has been slid down between the upright members 1 and pushed down until its base touches the surface upon which the stand is resting. In doing this some of the lower branches of the tree have ended up being positioned between the upright members 1 as shown. The tree is prevented from toppling over by the reaction force of the upright members 1. That is, in this stand, the stand maintains the tree in the upright position but the weight of the tree is supported, through its base, by the surface upon which the stand is placed.

Another aspect of the possible use of the stand is shown in FIG. 4. In cases where someone may wish to supply their Christmas tree with water or nutrients in order to increase the longevity of the tree the stand shown in FIG. 1 may accommodate a water container as is shown in FIG. 4. The container, in this case a water filled bowl, would be placed where the tree is to be situated the stand would be placed over and around this and then the tree would be slotted in to the position as described above. The bowl could be filled or refilled with water, soil, fertiliser or any other suitable material at any point during this process or at any other time whilst the tree is being displayed.

There are many variations of aspects of the invention and some of these are illustrated in the following figures. Where possible the figures show the invention as shown in FIG. 1 but with a single differing aspect such that an individual design variation may be illustrated. However, the Figures are merely an illustration of some of the possible individual variations and it is to be understood that the variation shown in any figure may be combined with one or more of the variations shown in other Figures to form a stand that is not illustrated.

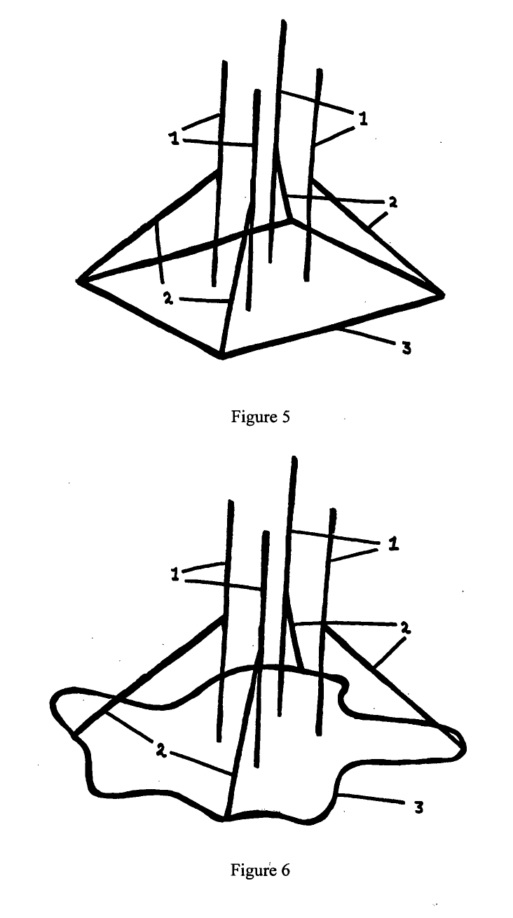

The connecting member 3 may be any shape as long as it contacts the ground over enough of its length, or at a substantial number of points, at a substantial radial distance from the desired position of the trunk of a displayed tree, such that the connecting member provides the stand with enough stability to prevent toppling in any given direction. For example FIG. 5 shows a stand with a connecting member 3 that is substantially square whilst FIG. 6 shows a stand in which the connecting member 3 is a flat but irregular shape.

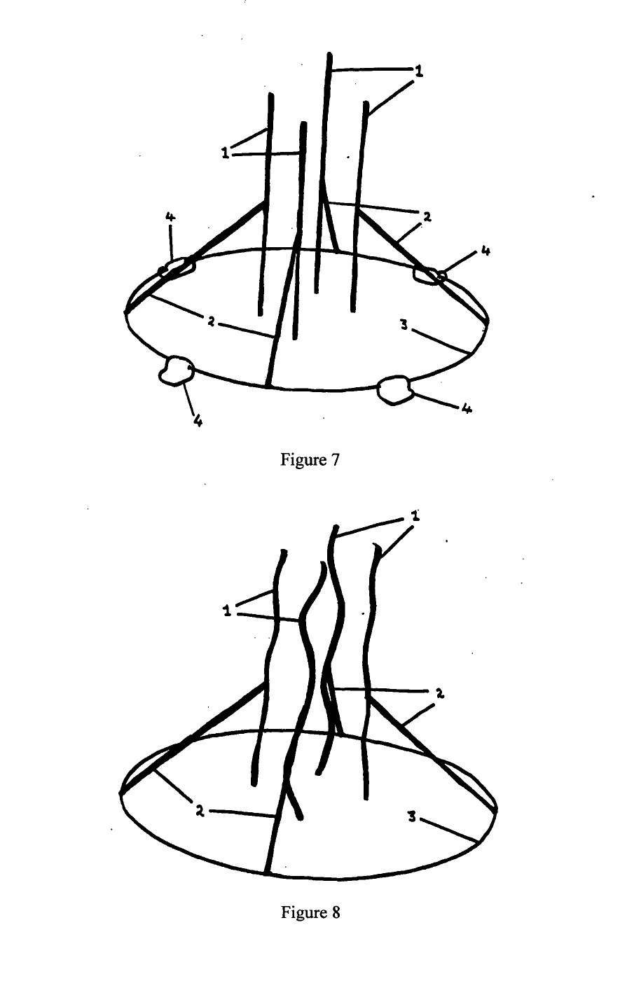

FIG. 7 shows a stand in which the connecting member 3 is flat, generally circular and is formed such that it has four feet 4 that are spaced regularly around the connecting member's circumference. When in use the stand rests on these feet 4 such that the main body of the connecting member 3 is raised off the surface upon which the stand is resting. This figure illustrates one possible size and shape of the feet 4 but there are many other possible sizes and shapes that would be possible but are not illustrated herein. Similarly although four feet 4 are illustrated, there may be a many differing numbers of feet 4 as long as there are at least three and they are positioned at positions on the connecting member 3 such that the stand may rest stably upon them when the stand is in use.

FIG. 8 shows a stand in which the upright members 1 have a decorative undulating shape. The upright members 1 may be any shape as long as they are separate and act to maintain a tree supported in the stand in the upright position.

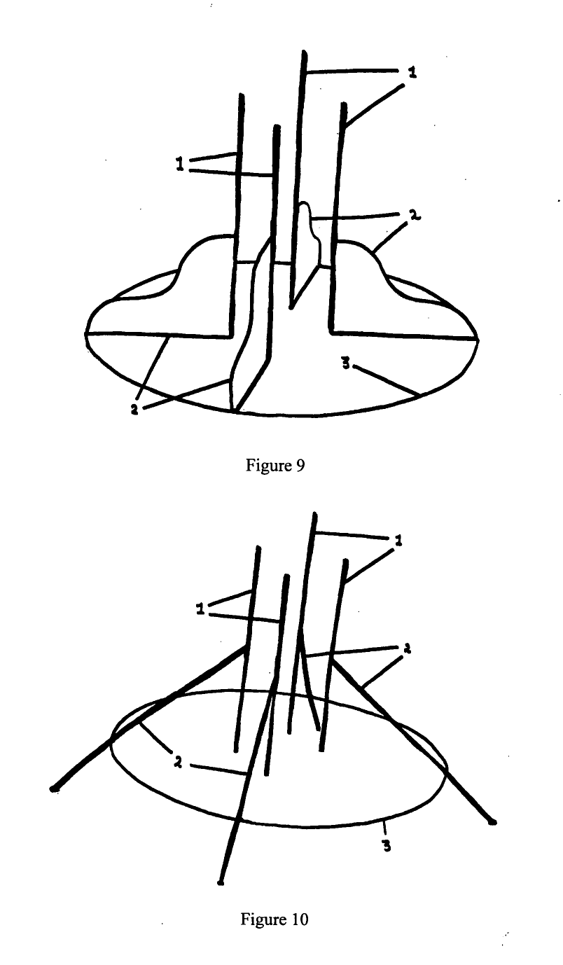

FIG. 9 shows a stand in which each supporting member 2 is made of sheet material that is joined to the upright member over a significant length from its base upwards at one of its edges and extends to the connecting member at its opposing end. The supporting members could of course be any shape as long as they join the connecting member 3 to the upright members 1 in a rigid fashion. For example rod-like supporting members may be designed such that a larger water bowl could be accommodated under them. Alternatively a stand designer may wish to produce decoratively shaped supporting members 2 made from sheet material with an intricate outline and with areas that have been cut out to form a Christmas themed design. The sheet material could be metal, a resilient plastic or any other suitable material that is capable of carrying the stresses exerted upon the supporting members when the stand is supporting a tree without significant plastic or elastic deformation.

FIG. 10 shows a stand in which the supporting members 2 extend beyond the connecting member 3 in both the downward and radially outward directions. This means that instead of resting upon the connecting member 3 this stand rests upon the outer ends of the supporting members 2 and the supporting members 2 bear the weight of the stand. Although this figure shows straight rod-like supporting members 2, supporting members that support the weight of the stand could be many other shapes, for example like those described in FIG. 2 or FIG. 9.

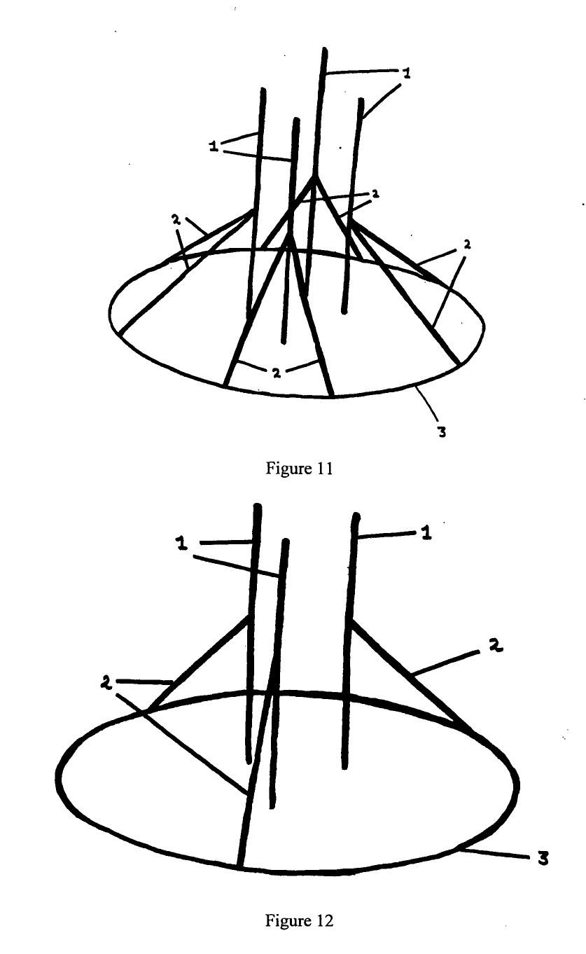

FIG. 11 shows a stand in which there is more than one supporting member 2 per upright member 1. There are two supporting members 2 fixing each upright member 1 to the connecting member 3. The two supporting members 2 are attached to the upright member 1 at the same point and extend to different points on the connecting member 3. This is only an example of a variation in the number of supporting members 2 per upright member 1. There may be any number of supporting members 2 per upright member 1 (within reason) and there may be differing numbers of supporting members 2 fixing each upright member 1 to the connecting member 3 in a single stand. Additionally if there are a plurality of supporting members 2 fixing an individual upright member 1 to the connecting member 3 they may each be fixed to the upright member 1 at any point along its length and may each be fixed to any point on the connecting member 3 as long as they do not cross the central space occupied by the lower trunk of the tree when the stand is in use.

The stands need not have four upright members 1. FIG. 12 shows a stand which has only three upright members 1. In a stand with only three upright members 1 they are preferably regularly spaced around the central space such that a tree placed in this space is evenly supported by each upright member 1 and there isn't a gap between any pair of upright members 1 that is large enough to allow the tree trunk to pass through.

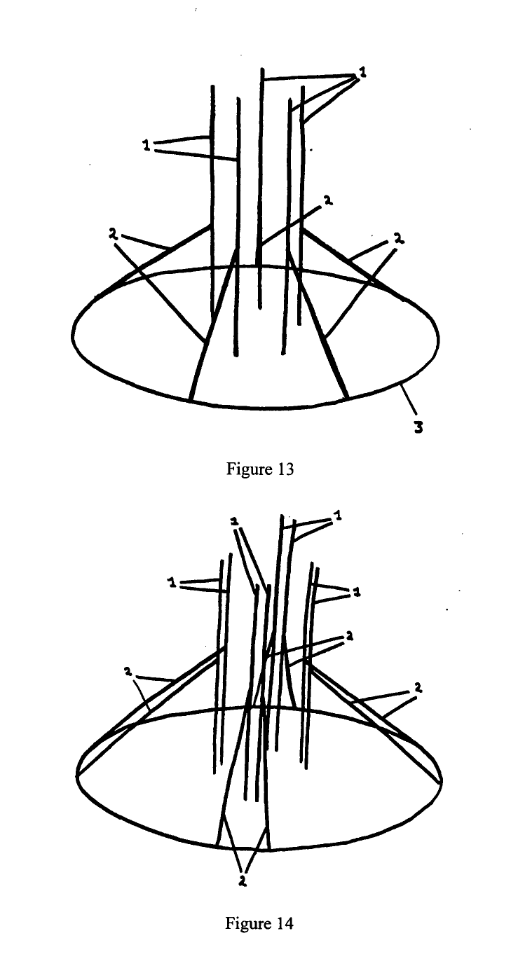

FIG. 13 shows a stand which has five regularly spaced upright members 1. Variations of the stand may have any number of upright members 1 within reason. Indeed stands with more upright members 1 will provide better support to the tree.

However the more upright members 1 there are the more costly the stand will be to manufacture and the less likely it will be that the lower branches of a tree could fit between the upright members 1.

FIG. 14 shows a stand which has eight irregularly spaced upright members 1. Upright members 1 in a given embodiment of the stand need not be regularly spaced. As long as they are positioned around the central space such that there is not a gap between any two neighbouring upright members 1 that is big enough for the trunk of the tree to pass through they may be positioned in any way. For example they may be positioned in pairs as is shown in FIG. 14, they may be fairly randomly spaced or even in a decorative pattern.

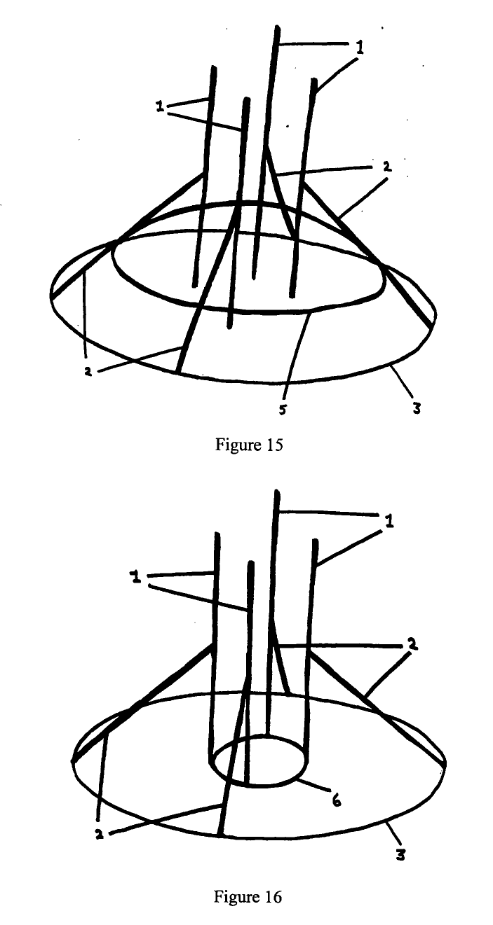

In order to increase the strength and rigidity of a stand it may have additional reinforcing members. FIG. 15 shows a stand in which there is a circular reinforcing member 5 joining the middles of the supporting members 2. This makes the stand stronger and more durable and better able to withstand the stresses of supporting a heavy Christmas tree over a long time period. A reinforcing member 5 positioned in this way could be varied in shape and construction in many ways. In fact it has even more freedom in design of its shape than the connecting member and could for example join each supporting member 2 at any position along its length. Furthermore a reinforcing member 5 need not join all the supporting members 2 and could just be a simple bar or rod joining two adjacent supporting members 2. In this case a single stand could have numerous reinforcing members 5.

FIG. 16 shows an alternative reinforcing member 6 in which the member 6 joins the bases of the upright members 1. This would also make the stand much stronger and more durable. In particular a reinforcing member 6 positioned in this way would lessen the stress on the joints between the upright member 1 and the supporting members 2 and would lessen the possibility of an upright member 1 being bent out of position by the weight of the tree. Again this reinforcing member 6 could be formed in a variety of shapes and from a variety of different materials as long as it did not pass through the central space intended for the trunk of a tree supported in the stand.

Just as for a reinforcing member 5 that extends between adjacent support members 2 a reinforcing member 6 that joins the upright members 1 need not be continuous and need not join all the upright members 1. Such a reinforcing member 6 could just join two upright members 1 and there may be many of them in a single stand. Furthermore a stand could be produced with a combination of reinforcing members 5 and 6 that join upright members 1 and supporting members 2 in order to produce an even more robust stand.

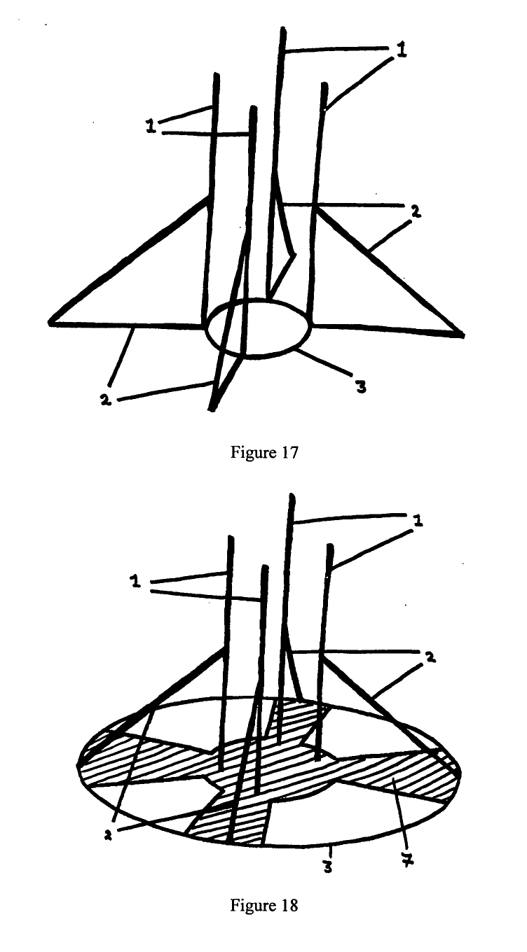

FIG. 17 shows a variation of the stand in which the connecting member 3 joins the bases of the upright members 1 instead of joining the supporting members 2 and in which the supporting members 2 are substantially triangular in shape. In this embodiment of the invention the weight of the stand is still mainly borne by the connecting member 3. However the radially outer ends of the supporting members 2 prevent the stand from toppling should a sideways force be applied to the stand or a tree it is supporting. In other words it is the supporting members 2 that provide stability to the stand. In this embodiment the supporting members 2 could be an almost infinite variety of shapes and could be made from a variety of materials as long as they have a radially outer portion that is level with the base of the stand. For example they could be straight horizontal rods that are joined to the bottom of the upright members 1, straight sloping rods that are joined to the upright members 1 at a height above their bases or even in sheet form joined to the upright members 1 over a significant length.

FIG. 18 shows an embodiment of the invention in which there is a partially solid base 7 to the stand. This base 7 would act as a reinforcing member that joins the bases of the upright members 1, the connecting member 3 and the lower ends of the supporting members 2 as well as providing a supporting surface for the base of the tree. The reinforcing action would make the stand much more rigid and durable. In use the base of a tree supported in this stand would have its weight borne by the base of the stand 7 instead of by the surface on which the stand is placed. This would enable a tree to be displayed on relatively delicate surfaces that may be easily damaged or stained by the weight or presence of a tree trunk. For example this stand would protect a carpet from contact with the tree trunk. However it would not be possible to place a bowl under this stand before erecting a tree because of the solid base 7. The base of the stand 7 could be made from a variety of materials for example wood, plastic sheet or sheet metal. The extent of the solid base 7 could also be varied from the example shown in FIG. 18. It could be an entirely solid base with the remainder of the stand fixed or resting on its upper surface or it could have cut away sections, for example as shown in FIG. 18. Alternatively it could even have a centre section cut away so that a tree trunk would not be supported by it but would pass through the cut away section and rest on the surface on which the stand is placed. In this case the base 7 could be thought of as a variation of a reinforcing member joining the bases of the upright members 1 to the connecting member 3 and outer ends of the supporting members 2.

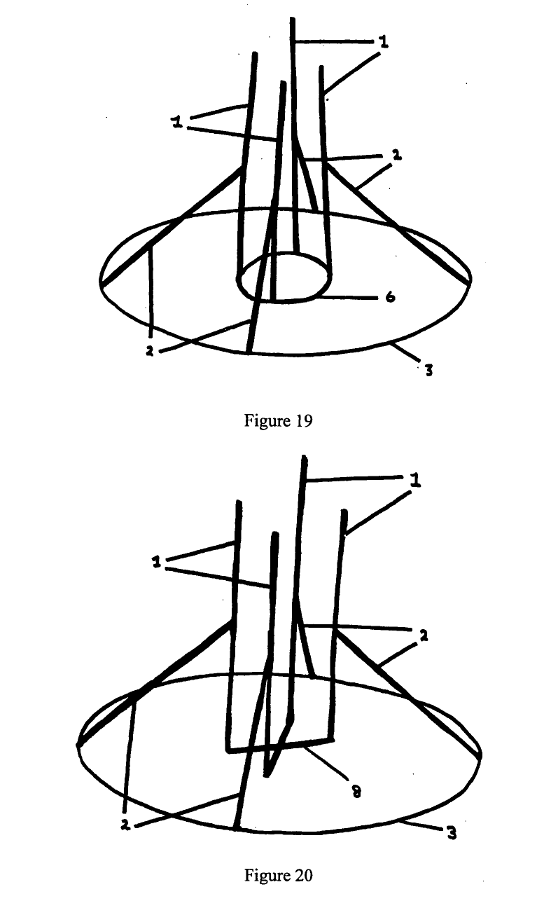

FIG. 19 shows an embodiment of the stand in which the upright members 1 are generally vertical and slightly slanted towards the centre of the stand. For a tree to be inserted into this stand the upright members 1 would need to be gently forced apart such that the trunk of the tree could fit between them and the tree would then be slid down between them. In order for this to work the upright members 1 need to be resilient and elastic such that they can withstand the deformation caused when they are forced outwards as a tree is inserted into the stand. For example they could be made of resilient grade of steel. These slanted upright members 1 would result in an inward pressure on the trunk of a tree placed in the stand from the upper end of each upright member 1. This pressure would be caused by the elastic deformation of the upright member 1. Thus the tree will be held more tightly against lateral movement. It is preferable that this embodiment of the invention has a reinforcing member 6 joining the lower ends of the upright members 1, as described above, such that the stress on each upright member-supporting member joint is minimised.

FIG. 20 shows an embodiment of the invention in which the lower ends of the upright members 1 are cross-linked together at 8 in such a manner that a tree being supported in the stand would have its weight directly born by this cross-linking 8.

This would mean that the stand would carry the weight of the tree as well as preventing it from toppling over. Obviously a stand constructed in this manner would also have to be sturdy enough to carry this weight. If the lower ends of the upright members 1 are significantly above the base of the stand the tree itself would be supported at the same height off the ground. Additionally the cross-linking 8 would act in much the same manner as the reinforcing member 6 shown in FIG. 16. The form of the cross-linking 8 need not be limited to that shown in FIG. 20 and could be any from as long as at least two of the upright members 1 were joined to each other by a link that provided a supporting surface for a tree positioned within the stand. However, preferably every upright member 1 should be joined to the others in such a manner such that the weight of the tree is distributed evenly between the upright members 1 and their associated supporting members 2.

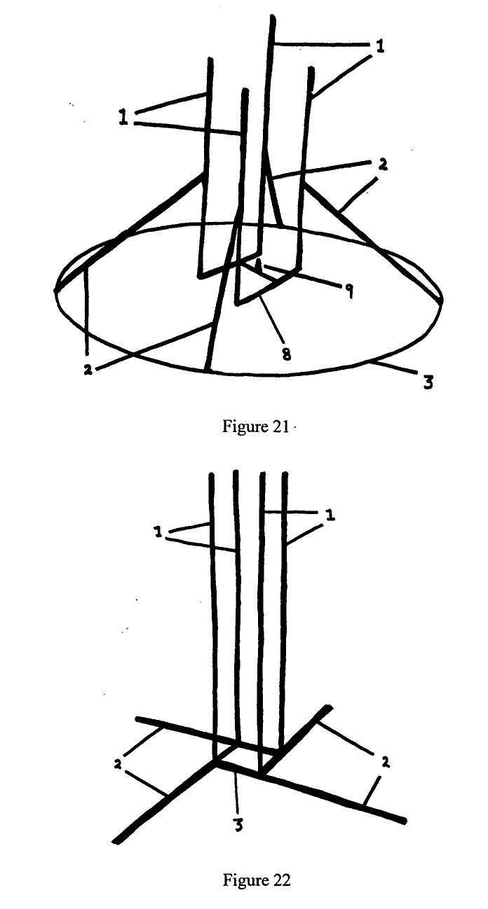

Preferably any cross-linking 8 of the lower ends of the upright members would also have some sort of locating member on its upper surface. For example the embodiment of the invention shown in FIG. 21 has a spike 9 in the centre of this cross linking 8. A tree displayed in the stand would be impaled upon this spike 9 by its own weight and therefore be fixed against lateral movement. This is particularly useful if the tree is not an exact fit for the stand i.e. if the trunk of the tree has a diameter less than that for which the stand is designed. Although the embodiment shown in FIG. 21 has a single spike 9 there could alternatively be a plurality of spikes or any other fixing that would prevent lateral movement of the base of the tree.

An example of a possible embodiment of a stand utilising a number of the above variations is shown in FIG. 22. The stand has four supporting members 2 that are horizontal and each attached to the lower end of one of four upright members 1. The supporting members do not extend directly radially outwards from the joint but instead extend in a direction that is parallel to an imaginary radial line originating from the midway point between the point at which the supporting member 2 is attached to its partner upright member 1 and the lower end of the adjacent upright member 1 in the anticlockwise direction. This slight variation gives this embodiment of the stand a more pleasing aesthetic quality and simplifies the manufacture of the stand. The connecting member 3 in this embodiment is square in shape, joins the lower ends of the upright members 1 and also acts as a cross-linking between the upright members 1. The major reason for the square shape of the connecting member 3 is so that the entire stand may be fabricated from steel rods. Each steel rod is provided with a right-angle bend in its middle portion such that it may form an upright member 1, one side of the connecting member 3 and the supporting member 2 that is attached to and parallel to that side of the connecting member 3. The four rods then be welded together at their bends so as to form the stand shown in FIG. 22. This simple construction would make the stands very cheap to manufacture on a large scale.

An added benefit of this design would be that if the upright members 1 were tapered together like those shown in FIG. 19 the stands would also be capable of being stacked upon each other. This would greatly reduce the space needed to store a number of these stands and thus reduce the manufacturing and shipping costs associated with this design. Many other designs would also be capable of stacking and as it would be too time consuming to go into the specific combination of design variations that would be required to enable the stands to stack it is to be understood that the person skilled in the art would easily be able to deduce such variations themselves.

An additional design feature that may be incorporated into any embodiment of the invention in which the upright members 1 are substantially rod-shaped is a screw joint in the upright members 1. Such a fixing would be situated at a substantially middle portion of the upright member 1. Specifically it would be situated above the height of the highest attachment said upright member has to its associated supporting member or members 2. It would enable the upright member 1 to be unscrewed at this point to form two separate lengths, an upper portion and a lower portion. The lower portion would remain an intrinsic and fixed part of the stand, whilst the upper portion would be entirely separate but could be easily reattached by simply screwing the two portions back together. The fixing would be formed by producing an axially threaded end on either the lower end of the upper portion or the upper end of the lower portion and providing a corresponding axial socket in the upper end of the lower portion or lower end of the upper portion respectively. A joint formed in this way would allow the removal of the upper portions of each upright member 1 simply be rotating the upper portions in the anticlockwise direction. It is envisaged that such a joint is so simple to use and manufacture that it would not detract from the non-mechanical nature of the invention and would be highly unlikely to be the cause of damage through repeated use. The purpose of this detaching mechanism is to reduce the storage space needed for each stand as disassembling a stand would greatly reduce it in both height and volume. This would reduce storage and transport costs for manufacturers, suppliers and retailers and also enable the end users to more easily store the stands between festive periods.

1. A tree stand substantially comprising at least three generally vertical upright members, at least as many supporting members as upright members and a continuous connecting member;
wherein said upright members are positioned such that the trunk of a tree may be slotted between and be supported by said upright members in a substantially upright position,
each supporting member is rigid, is fixed at one end to one of the upright members such that there is at least one supporting member attached to each upright member, and extends generally radially outwards from its associated upright member in such a manner that its other end is level with or lower than the base of the upright member to which it is attached and when the stand is in use the stand rests on and is supported by the connecting member or radially outmost end portions of all the supporting members;
and said continuous connecting member joins all of said upright members and all of said supporting members in a reinforcing manner such that the stand is a single rigid object.

2. A tree stand according to claim 1 in which there are four upright members.

3. A tree stand according to claim 1 in which the upright members are substantially formed from metal rods.

4. A tree stand according to claim 1 in which the supporting members are substantially formed from metal rods.

5. A tree stand according to claim 1 in which each supporting member is joined to the lower end of its associated upright member.

6. A tree stand according to claim 1 in which there is one supporting member attached to each upright member.

7. A tree stand according to claim 5 in which the supporting members are generally horizontal.

8. A tree stand according to claim 1 in which the connecting member is joined to the base of each upright member.

9. A tree stand according to claim 1 in which the connecting member is joined to the radially outer end of each supporting member.

10. A tree stand according to claim 1 in which the connecting member is substantially a metal hoop.

11. A tree stand according to claim 1 in which the connecting member is substantially formed from a metal rod.

12. A tree stand according to claim 1 in which the supporting members extend outwards from the point at which they are connected to the upright members in a downwards sloping manner.

13. A tree stand according to claim 1 in which the radially inner end of each supporting member is attached to an upright member at a point substantially above the lower end of said upright member.

14. A tree stand according to claim 1 in which the lower ends of the upright members are all at the same height.

15. A tree stand according to claim 1 in which the lower ends of at least two of the upright members are cross-linked such that said upright members are rigidly attached to one another and such that the weight of a tree slotted between said members will be supported by said cross-linking.

16. A tree stand according to claim 15 in which the lower ends of all the upright members are cross-linked.

17. A tree stand according to claim 16 in which said cross linking has at least one locating member on its upper surface such that the base of a tree supported by said cross-linking will be secured against lateral movement by said locating member or members.

18. A tree stand according to claim 17 in which there is a single locating member.

19. A tree stand according to claim 18 in which the locating member is a vertical spike.

20. A tree stand according to claim 14 in which the lower ends of the upright members are level with the base of the stand

21. A tree stand according to claim 14 in which the lower ends of all the upright members are substantially above the base of the stand.

22. A tree stand according to claim 1 in which the supporting members, upright members and connecting member are shaped and positioned such that a suitably shaped container may be situated within the stand in such a manner that the lower ends of the upright members of said stand are situated within said container and the connecting member of said stand is situated outside of said container in order that a tree supported within said stand may be supplied with water or other substances stored in the container.

23. A tree stand according to claim 1 in which the supporting members are substantially formed from sheet material.

24. A tree stand according to claim 23 in which the supporting members are substantially formed from sheet metal.

25. A tree stand according to claim 1 in which the upright members are spaced at regular and equal intervals around the circumference of a central space that has the shape of a vertical cylinder.

26. A tree stand according to claim 1 that is substantially made of steel.

27. A tree stand according to claim 26 that is made of plastic coated steel.

28. A tree stand according to claim 1 in which the connecting member is substantially formed from a sheet of rigid material.

29. A tree stand according to claim 28 in which the connecting member is a solid disc of rigid sheet material.

30. A tree stand according to claim 28 in which the connecting member is a disc of rigid sheet material containing a central hole situated such that the lower end of the trunk of a tree supported in said stand may pass through said hole.

31. A tree stand according to claim 28 in which the connecting member is joined to both the outer radial ends of the supporting members and the lower ends of the upright members.

32. A tree stand according to claim 1 in which the supporting members are substantially formed from metal bars.

33. A tree stand according to claim 1 in which the upright members are substantially formed from metal bars.

34. A tree stand according to claim 1 in which the connecting member is substantially formed from a metal bar.

35. A tree stand according to claim 1 in which the upright members and the supporting members are substantially made of wrought iron.

36. A tree stand according to claim 1 in which the upright members are generally elastic and resilient and are formed such that they taper inwards towards the centre of the stand.

37. A tree stand according to claim 1 in which the connecting member is substantially flat and rectangular.

38. A tree stand according to claim 1 in which the connecting member additionally comprises at least three feet members which are formed and positioned such that they support the stand in a stable manner when it is in use.

39. A tree stand according to claim 1 which additionally comprises at least one reinforcing member which directly joins at least two of the supporting members but which does not impinge upon the space in which the trunk of the tree is received when the stand is in use.

40. A tree stand according to claim 39 in which one of said reinforcing members comprises a hoop shaped member that joins all the supporting members.

41. A tree stand according to claim 1 which additionally comprises at least one reinforcing member that connects the lower ends of at least two of the upright members.

42. A tree stand according to claim 40 in which one of said reinforcing members comprises a hoop shaped reinforcing member that joins the lower ends of all the upright members.
